(19) United States
(12) Patent Application Publication
(10) Pub. No.: US 2013/0027823 A1
(43) Pub. Date: Jan. 31, 2013

(54) ELECTRIC APPARATUS WITH ESD PROTECTION EFFECT

(71) Applicants: KUN TAI WU, HSINCHU COUNTY (TW); CHIEN KUO WANG, HSINCHU COUNTY (TW)

(72) Inventors: KUN TAI WU, HSINCHU COUNTY (TW); CHIEN KUO WANG, HSINCHU COUNTY (TW)

(73) Assignee: RAYDIUM SEMICONDUCTOR CORPORATION, HSINCHU (TW)

(21) Appl. No.: 13/549,727

(22) Filed: Jul. 16, 2012

(30) Foreign Application Priority Data
Jul. 28, 2011 (TW) 100126727

(51) Int. Cl. H02H 9/04

(52) U.S. Cl. 361/56

(57) ABSTRACT

An electric apparatus with ESD protection effect is provided. The electric apparatus comprises a high-side unit, a low-side unit, and a level shifter. The high-side unit comprises a first pad and a second pad. The low-side unit comprises a third pad and a fourth pad. The level shifter is connected between the first pad and the fourth pad. The level shifter comprises a first resistor, a clamp element, a second resistor, and an N-type transistor. The first resistor is connected between the first pad and a first node. The clamp element is connected between the first pad and a second node. The second resistor is connected between the first node and the second node. The N-type transistor has a source and a body connected to the fourth pad, a drain connected to the first node, and a gate connected to the low-side unit.

### BACKGROUND

1. Technical Field

The present disclosure relates to an electric apparatus with electrostatic discharge (ESD) protection effect.

2. Background

ESD protection plays an important role in various circuit modules. The static voltage in the environment may be as high as several kilowatts per ampere. If a specific protection circuit is not provided to protect against the static voltage, a large static current from the high static voltage may damage the electric device. In order to improve the reliability of the electric apparatus, most electric apparatuses include an ESD protection circuit to prevent static current and protect other circuit modules inside the electric apparatus.

FIG. 1 illustrates a schematic view of a general ESD protection circuit applied for an illumination device 10. The illumination device 10 includes a high-side unit 12 and a low-side unit 14. Referring to FIG. 1, the high-side unit 12 includes pads 122, 124 and an ESD clamp circuit 126. The pad 122 is coupled to a first high voltage (e.g., 700V), while the pad 124 is coupled to a second high voltage (e.g., 680V). The ESD clamp circuit 126 is coupled between the pad 122 and the pad 124. The low-side unit 14 includes pads 142, 144 and an ESD clamp circuit 146. The pad 142 is coupled to a low voltage (e.g., 20V), while the pad 144 is coupled to ground. The ESD clamp circuit 146 is coupled between the pads 142 and 144. The ESD clamp circuit 126 and the ESD clamp circuit 146 are turned off in a normal operation status. However, when a very large current due to ESD is conducted in the illumination device 10 during an ESD event, the clamp circuits 126 and 146 will be turned on so as to conduct the very large current to the pad 124 or 144 so as to avoid damage in interior circuits 128 and 148.

In the prior art, a level shifter 16 is electrically connected between the high-side unit 12 and the low-side unit 14 so as to provide a converted voltage to the high-side unit 12. Referring to FIG. 1, the level shifter 16 includes an n-type metal-oxide-semiconductor (NMOS) transistor M₁, a current limiting resistor R₁ and a Zener diode D₁. When the NMOS M₁ cuts off, the voltage difference (about 700V) between the source and the drain thereof is the same as the voltage difference between the first high voltage and the ground. Therefore, the NMOS M₁ in practice requires a special transistor that can tolerate voltages in excess of 700V.

Referring to FIG. 2, in an ESD test of human body mode, a high voltage of about 2 KV is conducted into the high-side unit 12 through the pad 122. If the ESD clamp circuit 126 is turned off, the high voltage may be applied to the Zener diode D₁ and the NMOS transistor M₁, causing damage to the NMOS transistor M₁. Therefore, there is a demand for an improved ESD protection circuit to solve the above-mentioned problem.

### SUMMARY

The present disclosure provides an electric apparatus with ESD protection effect. The electric apparatus includes a high-side unit, a low-side unit and a level shifter. The high-side unit includes a first pad, a second pad and an ESD clamp circuit disposed between the first pad and the second pad. The low-side unit includes a third pad, a fourth pad and an ESD clamp circuit disposed between the third pad and the fourth pad. The level shifter is coupled between the first pad of the high-side unit and the fourth pad of the low-side unit. The level shifter includes a first resistor, a clamp element, a second resistor and a first N-type transistor. The first resistor is coupled between the first pad and a first node. The clamp element is coupled between the first pad and a second node. The second resistor is coupled between the first node and the second node. The first N-type transistor has a source, a gate and a drain. The source and the first N-type transistor are coupled to the fourth pad. The drain is coupled to the first node. The gate is coupled to the low-side unit.

The foregoing has outlined rather broadly the features and technical benefits of the disclosure in order that the detailed description of the disclosure that follows may be better understood. Additional features and benefits of the disclosure will be described hereinafter, and form the subject of the claims of the disclosure. It should be appreciated by those skilled in the art that the conception and specific embodiment disclosed may be readily utilized as a basis for modifying or designing other structures or processes for carrying out the same purposes of the disclosure. It should also be realized by those skilled in the art that such equivalent constructions do not depart from the spirit and scope of the disclosure as set forth in the appended claims.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures, and:

FIG. 1 illustrates a schematic view of a general ESD protection circuit applied for an illumination device;

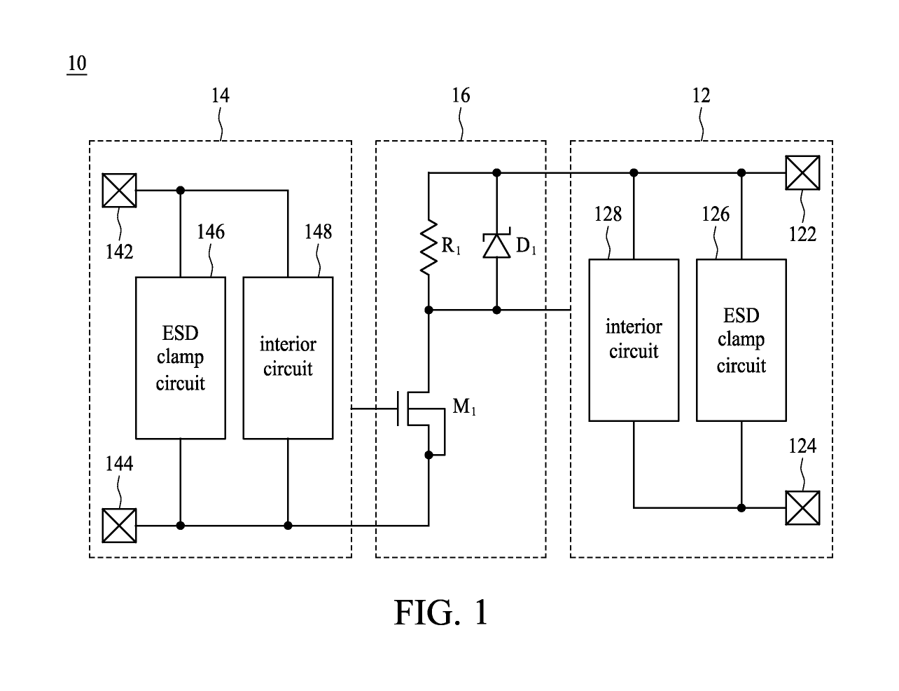

FIG. 2 is a schematic view of an ESD test of human body mode;

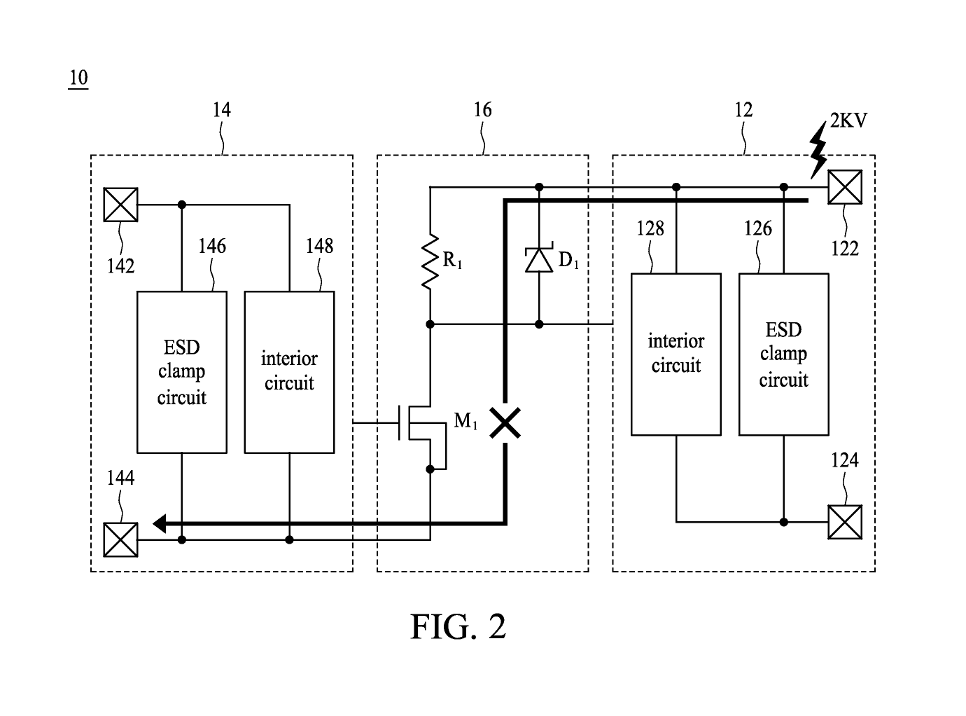

FIG. 3 is schematic view of an electric apparatus with ESD protection effect in accordance with an embodiment of the present disclosure; and

FIG. 4 is a schematic view of an ESD test of human body mode in the above-mentioned electric apparatus with ESD protection effect.

### DETAILED DESCRIPTION

The following description of the disclosure accompanies drawings, which are incorporated in and constitute a part of this specification, and illustrate embodiments of the disclosure, but the disclosure is not limited to the embodiments. In addition, the following embodiments can be properly integrated to complete another embodiment.

References to “one embodiment,” “an embodiment,” “exemplary embodiment,” “other embodiments,” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

The present disclosure is directed to an electric apparatus with ESD protection effect. In order to make the present disclosure comprehensible, detailed steps and structures are provided in the following description. Obviously, implementation of the present disclosure does not limit special details known by persons skilled in the art. In addition, known structures and steps are not described in detail, so as not to limit the present disclosure unnecessarily. Preferred embodiments of the present disclosure will be described below in detail. However, in addition to the detailed description, the present disclosure may also be widely implemented in other embodiments. The scope of the present disclosure is not limited to the detailed description, and is defined by the claims.

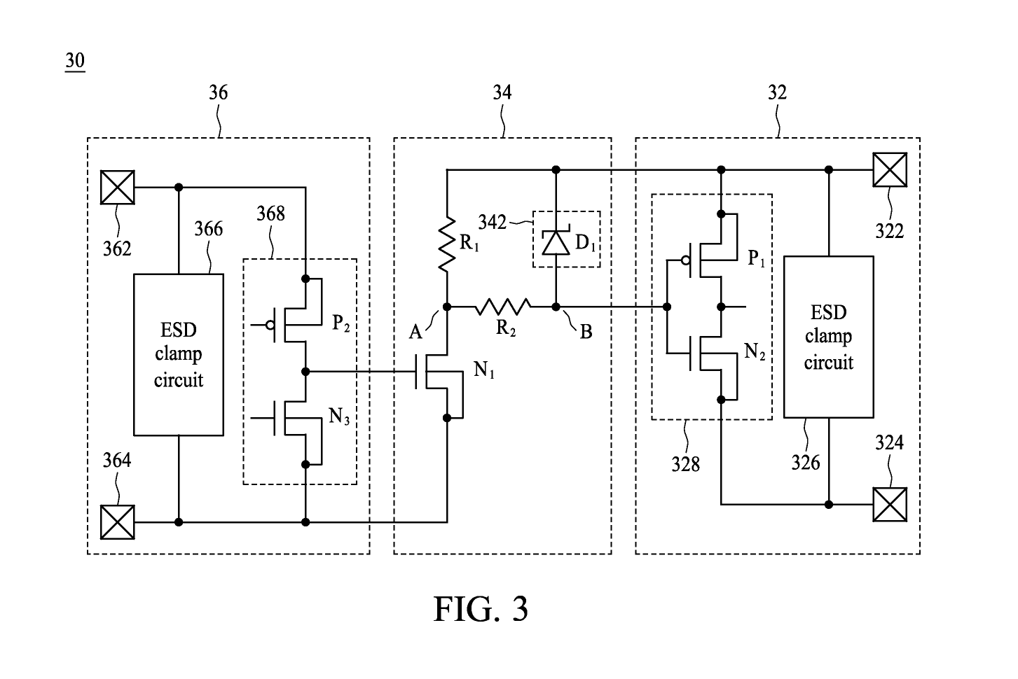

FIG. 3 illustrates a schematic view of an electric apparatus 30 with ESD protection effect in accordance with one embodiment of the present disclosure. Referring to FIG. 3, the electric apparatus 30 includes a high-side unit 32, a level shifter 34 and a low-side unit 36. The level shifter 34 is coupled between the high-side unit 32 and the low-side unit 36.

Referring to FIG. 3, the high-side unit 32 includes pads 322 and 324, an ESD clamp circuit 326 and a buffer unit 328. The pad 322 is coupled to a first high voltage (e.g., 700V), while the pad 324 is coupled to a second high voltage (e.g., 680V). The ESD clamp circuit 326 is coupled between the pad 322 and the pad 324. The buffer unit 328 is configured to provide a corrected digital signal to a core circuit (not shown) of the high-side unit 32.

The low-side unit 36 includes pads 362 and 364, an ESD clamp circuit 366 and a buffer unit 368. The pad 362 is coupled to a first low voltage (e.g., 20V), while the pad 364 is coupled to ground. The ESD clamp circuit 366 is coupled between the pads 362 and 364. The buffer unit 368 is configured to provide a corrected digital signal to a core circuit (not shown) of the low-side unit 36.

Referring to FIG. 3, the level shifter 34 includes an NMOS transistor N₁, resistors R₁ and R₂ and a clamp element 342. Impedance of the resistor R₁ ranges from 2000 to 8000 ohm, while impedance of the resistor R₂ ranges from 300 to 1000 ohm. The resistor R₁ is coupled between the pad 322 of the high-side unit 32 and a node A. The clamp element 342 is coupled between the pad 322 of the high-side unit 32 and a node B. The resistor R₂ is coupled between the node A and the node B. The NMOS transistor N₁ includes a source, a gate and a drain. The source of the transistor N₁ is coupled to the pad 364 of the low-side unit 36. The drain of the transistor N₁ is coupled to the resistors R₁ and R₂ at the node A, while the gate of the transistor N₁ is coupled to buffer unit 368 of the low-side unit 36. The level shifter 34 is configured to provide a converted voltage to the buffer unit 328 of the high-side unit 32.

In normal operation, as shown in FIG. 3, the ESD clamp circuits 326 and 366 are kept at an off state. The NMOS transistor N₁ may be turned on by an output signal of the buffer unit 368. In the present embodiment, the buffer unit 368 includes a P-type transistor P₂ and an N-type transistor N₃, which are connected between the pad 362 and the pad 364, while the buffer unit 328 includes another P-type transistor P₁ and another N-type transistor N₂, which are connected between the pad 322 and the pad 324. When the N-type transistor N₃ of the buffer unit 368 is turned on, the buffer unit 368 outputs a voltage signal of 0V to allow the NMOS transistor N₁ to turn off. When the NMOS transistor N₁ is turned off, the voltage level at the node A is 700V and the N-type transistor N₂ of the buffer unit 328 outputs a voltage signal of 680V.

In contrast, when the P-type transistor P₂ of the buffer unit 368 is turned on, the buffer unit 368 outputs a voltage signal of 20V so as to activate or turn on the NMOS transistor N₁. When the NMOS transistor N₁ is turned on, the resistor R₁, which serves as a current limiting resistor, adjusts the working current in the N-type transistor N₁. Meanwhile, the clamp element 342 will be turned on to limit the voltage level at the node B so as to limit the voltage between the source and the gate of the P-type transistor P₁. In the present embodiment, the clamp element 342 includes but is not limited to a Zener diode D₁, the voltage drop of which can be adjusted to 8V. Meanwhile, the PMOS transistor P₁ outputs a voltage signal of 700V.

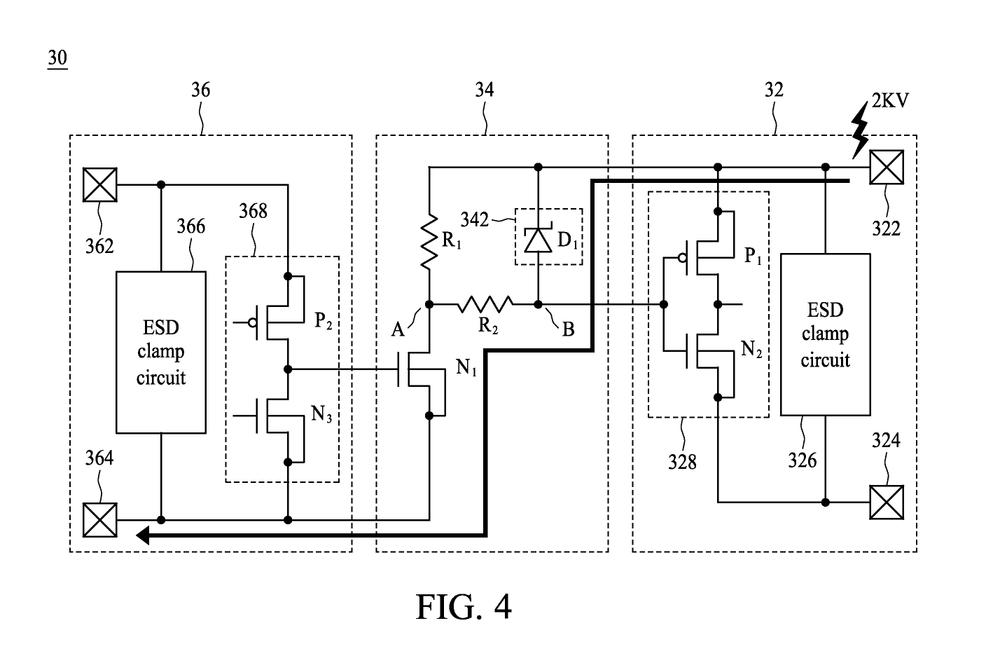

Referring to FIG. 4, in the ESD test of the human body mode, a high static voltage of 2 KV emulating an ESD event is conducted to the circuit of the high-side unit 32 through the pad 322. If the ESD clamp circuit 326 is turned off, the high voltage will be applied to the Zener diode D₁, resistor R₂ and the NMOS transistor N₁. The impedance of the resistor R₂ is designed to reduce the voltage drop between the source and the drain of the NMOS transistor N₁. In other words, impedance of the resistor R₂ is designed to maintain the voltage drop between the nodes A and B at a constant ranging from 1200 V to 1400 V (preferably 1300 V) in response to the current through the resistor R₂. In an exemplary embodiment of the present disclosure, the sum of the value of the high static voltage minus the total value of the voltage drops of the clamp element 342 and the resistor R₂ is smaller than the breakdown voltage value (e.g., 700V) of the NMOS transistor N₁. Therefore, by such design including the resistor R₂, if the ESD clamp circuit 326 is turned off, the NMOS transistor N₁ can tolerate the high static voltage due to ESD and avoid the damage caused by an ESD event.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An electric apparatus with electrostatic discharge (ESD) protection effect, the electric apparatus comprising:
a high-side unit including a first pad, a second pad and a first ESD clamp circuit disposed between the first pad and the second pad;
a low-side unit including a third pad, a fourth pad and a second ESD clamp circuit disposed between the third pad and the fourth pad; and
a level shifter coupled between the first pad of the high-side unit and the fourth pad of the low-side unit, wherein the level shifter includes:
a first resistor coupled between the first pad and a first node;
a clamp element coupled between the first pad and a second node;
a second resistor coupled between the first node and the second node; and
a first N-type transistor having a source, a drain and a gate, wherein the source and the N-type transistor are coupled to the fourth pad, the drain is coupled to the first node, and the gate is coupled to the low-side unit.

2. The electric apparatus according to claim 1, wherein when the first pad receives a high static voltage, the sum of the value of the high static voltage minus the total value of the voltage drops of the clamp element and the second resistor is smaller than the breakdown voltage value of the first N-type transistor.

3. The electric apparatus according to claim 2, wherein the clamp element is a Zener diode.

4. The electric apparatus according to claim 3, wherein the first pad is configured to receive a first high voltage, the second pad is configured to receive a second high voltage, and the voltage difference of Zener diode is smaller than the voltage difference of the first high voltage and the second high voltage.

5. The electric apparatus according to claim 1, wherein the high-side unit further includes a first P-type transistor and a second N-type transistor, wherein the first P-type transistor and the second N-type transistor are electrically connected between the first pad and the second pad, and a gate of the first P-type transistor and a gate of the second N-type transistor are coupled to the second node.

6. The electric apparatus according to claim 1, wherein the low-side unit further includes a second P-type transistor and a third N-type transistor, wherein the second P-type transistor and the third N-type transistor are electrically connected between the third pad and the fourth pad, and a drain of the second P-type transistor and a drain of the third N-type transistor are coupled to the gate of the first N-type transistor.

7. The electric apparatus according to claim 1, wherein the impedance of the first resistor is adjusted in accordance with the working current of the first N-type transistor.

8. A level shifter with electrostatic discharge (ESD) protection effect, the level shifter comprising:
a clamp element coupled to a first pad where a high static voltage is conducted;
a first N-type transistor having a drain, wherein the drain is coupled to the clamp element;
a second resistor coupled among the clamp element and the drain, wherein the impedance of the second resistor is adjusted to allow the sum of the value of the high static voltage minus the total value of the voltage drops of the clamp element and the second resistor to be smaller than the breakdown voltage value of the first N-type transistor.

9. The level shifter according to claim 8, further comprising a first resistor coupled to the first pad and limiting the current passing through the first resistor.

10. The level shifter according to claim 9, wherein the first N-type transistor has a source coupled to a fourth pad coupled to ground, and the drain is coupled to the first resistor, and wherein the second resistor is coupled among the clamp element, the first resistor and the drain.

11. An electric apparatus with electrostatic discharge (ESD) protection effect, the electric apparatus comprising:
a high-side unit including a first pad;
a low-side unit including a fourth pad; and
a level shifter coupled between the first pad and the fourth pad, wherein the level shifter includes:
a clamp element coupled between the first pad where a high static voltage is conducted;
a first N-type transistor having a drain coupled to the clamp element; and
a second resistor coupled among the clamp element and the drain, wherein the impedance of the second resistor is adjusted to allow the sum of the value of the high static voltage minus the total value of the voltage drops of the clamp element and the second resistor to be smaller than the breakdown voltage value of the first N-type transistor.

12. The electric apparatus according to claim 11, wherein the high-side unit further includes a second pad and a first ESD clamp circuit disposed between the first pad and the second pad, and the low-side unit further includes a third pad and a second ESD clamp circuit disposed between the third pad and the fourth pad.

13. The electric apparatus according to claim 12, wherein the level shifter further includes a first resistor coupled between the first pad and a first node, and the first resistor limits the current passing through the first resistor

14. The electric apparatus according to claim 13, wherein the clamp element is coupled between the first pad and a second node, the first N-type transistor further has a source, and a gate, and wherein the source is coupled to the fourth pad, the drain is coupled to the first node, and the gate is coupled to the low-side unit, and the second resistor is coupled between the first node and the second node.

15. The electric apparatus according to claim 14, wherein when the first pad receives a high static voltage, the sum of the value of the high static voltage minus the total value of the voltage drops of the clamp element and the second resistor is smaller than the breakdown voltage value of the first N-type transistor.

16. The electric apparatus according to claim 15, wherein the clamp element is a Zener diode.

17. The electric apparatus according to claim 16, wherein the first pad is configured to receive a first high voltage, the second pad is configured to receive a second high voltage, and the voltage difference of Zener diode is smaller than the voltage difference of the first high voltage and the second high voltage.

18. The electric apparatus according to claim 14, wherein the high-side unit further includes a first P-type transistor and a second N-type transistor, wherein the first P-type transistor and the second N-type transistor are electrically connected between the first pad and the second pad, and a gate of the first P-type transistor and a gate of the second N-type transistor are coupled to the second node.

19. The electric apparatus according to claim 14, wherein the low-side unit further includes a second P-type transistor and a third N-type transistor, wherein the second P-type transistor and the third N-type transistor are electrically connected between the third pad and the fourth pad, and a drain of the second P-type transistor and a drain of the third N-type transistor are coupled to the gate of the first N-type transistor.

20. The electric apparatus according to claim 14, wherein the impedance of the first resistor is adjusted in accordance with the working current of the first N-type transistor.
